(19) United States
(12) Patent Application Publication
(10) Pub. No.: US 2026/0212050 A1
(43) Pub. Date: Jul. 23, 2026

(54) Physical Encryption Techniques For Memory Devices

(71) Applicant: Sandisk Technologies, Inc., Milpitas, CA (US)

(72) Inventors: Guoqin Guan, Shanghai (CN); Liang Li, Shanghai (CN); Yinfeng Yu, Shanghai (CN)

(21) Appl. No.: 19/032,927

(22) Filed: Jan. 21, 2025

(51) Int. Cl. G06F 21/79; G06F 21/60

(52) U.S. Cl. CPC G06F 21/79; G06F 21/602

(57) ABSTRACT

Examples described herein provide data storage devices with physical encryption. One example provides a data storage device including a circuit including a memory cell and a source ground source transistor on a cell source path of the memory cell. When the circuit is in a decryption mode, the source ground source transistor is in an off state and the memory cell has an effective read voltage at a first level. When the circuit is in an encryption mode, the source ground source transistor is in an on state and the memory cell has an effective read voltage at a second level different from the first level.

### FIELD

This application relates generally to data storage devices, and more particularly, to data storage devices with physical encryption circuitry.

### BACKGROUND

Non-volatile memory, such as three-dimensional (3D) NAND flash memory, is widely used for storage and data transfer in consumer devices, enterprise systems, and industrial applications due to its nonvolatile characteristics, affordability, high storage density, and access speeds. Encryption techniques are commonly implemented for data security of data storage devices. Typically, encryption is divided into software encryption and hardware encryption. Software encryption includes the use of software to encrypt and decrypt data, and is cost-effective in small application environments.

### SUMMARY

While common, software encryption may demand processing resources that could otherwise be dedicated towards the performance of the data storage device. Additionally, software encryption is easier to overcome than hardware encryption, as powerful algorithms may be implemented to attack and potentially break the software encryption. Physical encryption, however, is safer than software encryption as an attacker cannot obtain the secret key without knowing the specific physical structure of the chip or data storage device.

Examples described herein provide physical encryption methods and circuitry for data storage devices, such as NAND flash memory. For example, an encryption mode may be enabled to make read data different from stored data. Exiting the encryption mode makes read data correct. Users can erase and write data when under the encryption mode. Various circuit components, such as MOSFETs, may be implemented to control whether the data storage device is in the encryption mode.

One embodiment of the present disclosure includes a data storage device. The data storage device includes a circuit including a memory cell and a source ground source transistor on a cell source path of the memory cell. When the circuit is in a decryption mode, the source ground source transistor is in an off state and the memory cell has an effective read voltage at a first level. When the circuit is in an encryption mode, the source ground source transistor is in an on state and the memory cell has an effective read voltage at a second level different from the first level.

Another embodiment of the present disclosure includes a data storage device. The data storage device includes a memory cell, a source ground source transistor on a cell source path of the memory cell, and a controller. The controller is configured to control, when in an decryption mode, the source ground source transistor to an off state, wherein, when in the decryption mode, the memory cell has an effective read voltage at a first level, and control, when in an encryption mode, the source ground source transistor to an on state, wherein, when in the encryption mode, the memory cell has an effective read voltage at a second level different from the first level.

Yet another embodiment of the present disclosure includes a method for physical encryption in a data storage device. The method includes controlling, when in a decryption mode, a source ground source transistor to an off state, where, when in the decryption mode, a memory cell has an effective read voltage at a first level, where the source ground source transistor is on a cell source path of the memory cell; and controlling, when in an encryption mode, the source ground source transistor to an on state, where, when in the encryption mode, the memory cell has an effective read voltage at a second level different from the first level.

Various aspects of the present disclosure provide for improvements in data storage devices. The present disclosure can be embodied in various forms, including hardware or circuits controlled by software, firmware, or a combination thereof. The foregoing summary is intended solely to give a general idea of various aspects of the present disclosure and does not limit the scope of the present disclosure in any way.

### BRIEF DESCRIPTION OF THE DRAWINGS

FIG. 1 is a block diagram illustrating a system including a data storage device and a host device, in accordance with some embodiments of the disclosure.

FIG. 2 is a circuit diagram illustrating a circuit that is performing an erase operation on a memory cell, in accordance with some embodiments of the disclosure.

FIG. 3 is a circuit diagram illustrating a circuit that is performing an erase verify operation on a memory cell, in accordance with some embodiments of the disclosure.

FIG. 4 is a circuit diagram illustrating a circuit that is performing a program operation on a memory cell, in accordance with some embodiments of the disclosure.

FIG. 5 is a circuit diagram illustrating a circuit that is performing a program verify operation on a memory cell, in accordance with some embodiments of the disclosure.

FIG. 6 is a circuit diagram illustrating a circuit that is performing a read operation on a memory cell while the circuit is in an encryption mode, in accordance with some embodiments of the disclosure.

FIG. 7 is a circuit diagram illustrating a circuit that is performing a read operation on a memory cell while the circuit is in a decryption mode, in accordance with some embodiments of the disclosure.

FIG. 8 is a graph illustrating the effective read voltage during read operations based on whether the encryption mode is enabled, in accordance with some embodiments of the disclosure.

FIG. 9 is a circuit diagram illustrating a circuit that is performing a power-on read operation on a memory cell, in accordance with some embodiments of the disclosure.

FIG. 10 is a table providing the state of a source ground source transistor for various operations, in accordance with some embodiments of the disclosure.

FIG. 11 is a flowchart illustrating an example method for changing from an encryption mode to a decryption mode of a data storage device, in accordance with some embodiments of the disclosure.

### DETAILED DESCRIPTION

In the following description, numerous details are set forth, such as data storage device configurations, controller operations, and the like, in order to provide an understanding of one or more aspects of the present disclosure. It will be readily apparent to one skilled in the art that these specific details are merely exemplary and not intended to limit the scope of this application. In particular, the functions associated with the controller can be performed by hardware (for example, analog or digital circuits), a combination of hardware and software (for example, program code or firmware stored in a non-transitory computer-readable medium that is executed by a processor or control circuitry), or any other suitable means. The following description is intended solely to give a general idea of various aspects of the present disclosure and does not limit the scope of the disclosure in any way. Furthermore, it will be apparent to those of skill in the art that, although the present disclosure refers to NAND flash, the concepts discussed herein may be applicable to other types of solid-state memory, such as NOR, PCM (“Phase Change Memory”), ReRAM, or other suitable solid-state memory.

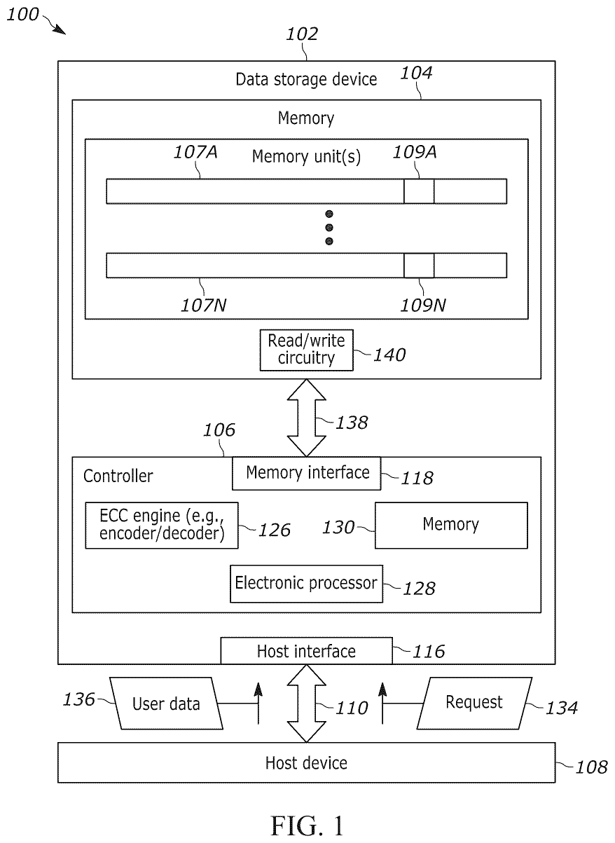

FIG. 1 is a block diagram of one example of a system 100 that includes a data storage device 102. In some implementations, the data storage device 102 is a flash memory device. For example, the data storage device 102 is a Secure Digital SD® card, a microSD® card, a hard drive such as an external hard drive, or another similar type of data storage device. The data storage device 102 illustrated in FIG. 1 includes a memory 104 (e.g., a non-volatile memory) and a controller 106 (referred to hereinafter as “data storage device controller”) coupled to the memory 104.

The data storage device 102 is coupled to a host device 108. The host device 108 is configured to provide data 110 (for example, user data 136) to the data storage device 102 to be stored, for example, in the memory 104. The host device 108 is, for example, a smart phone, a music player, a video player, a gaming console, an e-book reader, a personal digital assistance device, a tablet, a notebook computer, or another similar device.

In some implementations, the memory 104 is NAND flash memory. The memory 104 illustrated in FIG. 1 includes a plurality of memory units 107A-107N (for example, flash memory units). Each of the plurality of memory units 107A-107N includes a plurality of storage elements. For example, in FIG. 1, the memory unit 107A includes a representative storage element 109A. In some implementations, the storage element 109 is a multi-level cell flash memory, such as a 2 levels cell (“SLC”), a 4 levels cell (“MLC”), an 8 levels cell (“TLC”), a 16 levels cell (“QLC”), or a flash memory cell having a larger number of bits per cell (for example, between five and ten bits per cell). In some implementations, the plurality of memory units 107A-107N are memory dies configured to store data. In such implementation, each storage element 109 may be a block of memory.

The data storage device controller 106 illustrated in FIG. 1 includes a host interface 116, a memory interface 118, an error code correction (ECC) engine 126, and an electronic processor or processing circuitry 128. The data storage device controller 106 is illustrated in FIG. 1 in a simplified form. One skilled in the art would recognize that a controller for a non-volatile memory would include additional modules or components other than those specifically illustrated in FIG. 1. Additionally, although the data storage device 102 is illustrated in FIG. 1 as including the data storage device controller 106 and modules for performing, for example, flag setting, in other implementations, the data storage device controller 106 is instead located within the host device 108 or is otherwise separate from the data storage device 102. As a result, flash translation layer (“FTL”) operations and flash module (“FM”) operations that would normally be performed by the data storage device controller 106 (for example, wear leveling, bad block management, data scrambling, garbage collection, address mapping, etc.) can be performed by the host device 108 or another device that connects to the data storage device 102.

The data storage device controller 106 is configured to send data to, and receive data and instructions from, the host device 108 with the host interface 116. The host interface 116 enables the host device 108 to, for example, read from the memory 104 by transmitting requests 134 and to write to the memory 104 by sending user data 136 and using any suitable communication protocol. Suitable communication protocols include, for example, the Universal Flash Storage (“UFS”) Host Controller Interface specification, the Secure Digital (“SD”) Host Controller specification, etc.

The data storage device controller 106 is also configured to send data and commands to (e.g., the user data 136, the requests 134), and receive data from, the memory 104 with the memory interface 118. As an illustrative example, the data storage device controller 106 is configured to send data and a write command to instruct the memory 104 to store data in a particular memory location in the memory 104. The memory 104 writes the data to the plurality of memory units 107A-107N using read/write circuitry 140. The data storage device controller 106 is also configured to send a read command to the memory 104 to cause a read of data from a particular memory location in the memory 104 using the read/write circuitry 140. In some examples, the data storage device controller 106 is coupled to the non-volatile memory 104 with a bus 138 in combination with the memory interface 118.

The data storage device controller 106 illustrated in FIG. 1 includes an electronic processor 128 (for example, a microprocessor, a microcontroller, a field-programmable gate array [“FPGA”] semiconductor, an application specific integrated circuit [“ASIC”], or another suitable programmable device) and a non-transitory computer readable medium or memory 130 (for example, including random access memory [“RAM”] and read only memory [“ROM”]). The electronic processor 128 is operatively connected to the various modules within the data storage device controller 106 and the data storage device 102. For example, firmware is loaded in a ROM of the memory 130 as computer executable instructions. Those computer executable instructions are capable of being retrieved from the memory 130 and executed by the electronic processor 128 to control the operation of the data storage device 102 and perform the processes described herein (for example, flag setting and read operations). In some implementations, one or more modules of the data storage device controller 106 correspond to separate hardware components within the data storage device controller 106. In other implementations, one or more modules of the data storage device controller 106 correspond to software stored within the memory 130 and executed by the electronic processor 128. The memory 130 is configured to store data used by the electronic processor 128 during operation.

Examples described herein provide a physical encryption mode for data storage devices. For example, when under specific usage scenarios where data security is imperative, a special NAND chip may be provided under an encryption mode as the default condition. When in the encryption mode, a user can erase or write data to the data storage device as normal. However, data cannot be correctly read from the data storage device while the data storage device is in the encryption mode. Assuming the data is read from the data storage device, while the data is still intact, the data that is provided is incorrect due to a shift in the cell read voltage. To read the data correctly, the user may cause the data storage device to enter into a decryption mode by entering a designated command and/or a secret key. When the secret key is correct (e.g., fitted), the data storage device enters the decryption mode and data may be read correctly.

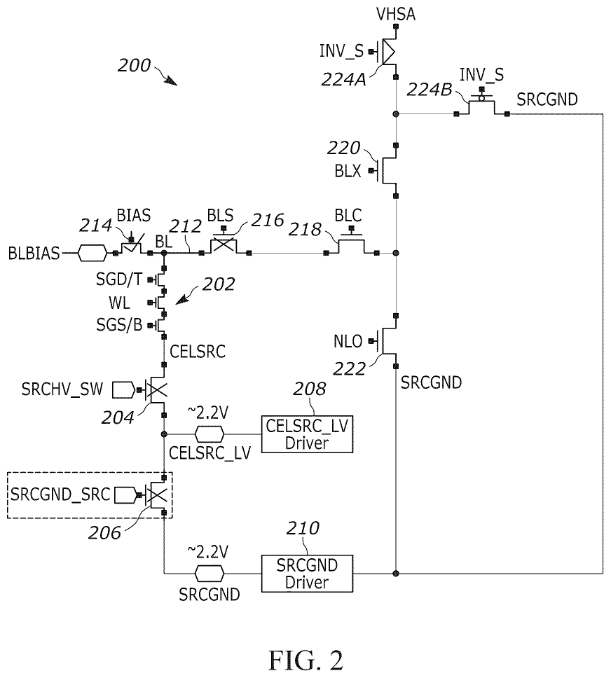

FIG. 2 is a circuit diagram of circuit 200 for controlling read/write/erase operations for a memory cell 202. The circuit 200 may be implemented in the memory 104 (for example, implemented as part of the read/write circuitry 140). The memory cell 202 may be the memory unit 107A. In some examples, the memory cell 202 is an array of memory cells. The circuit 200 includes a source high voltage switch (SRCHV_SW) 204 and a source ground source transistor (SRCGND_SRC) 206 along a cell source (CELSRC) path of the memory cell 202. The source high voltage switch 204 is connected to a first end node of the memory cell 202. A cell source low voltage (CELSRC_LV) driver 208 is configured to provide a voltage between the source high voltage switch 204 and the source ground source transistor 206 (e.g., at a first input of the source ground source transistor 206). A source ground (SRCGND) driver 210 is configured to provide a voltage at a second input of the source ground source transistor 206. The voltages provided by the cell source low voltage driver 208 and the source ground driver 210 may vary based on whether data is being read from, written to, or erased from the memory cell 202.

A bit line (BL) 212 is connected to a second end node of the memory cell 202. The bit line 212 is the metal line of the drain side of the memory cell 202. The circuit 200 includes a BIAS transistor 214 which is a transistor that controls whether an erase voltage bias is conducted. The BIAS transistor 214 is connected to the bit line 212 and receives a bit line bias (BLBIAS) voltage. A bit line select (BLS) transistor 216 is also connected to the bit line 212. The bit line select transistor 216 is a transistor that controls whether the bit line 212 is connected to a bit line control (BLC transistor 218. The bit line control (BLC) transistor 218 may also be provided as a transistor that controls whether the BLS transistor 216 is connected to a BLX transistor 220 and/or a non-lock-out (NLO) transistor 222.

The BLX transistor 220 is provided in the circuit 200 as a low voltage transistor that controls whether the bit line control transistor 218, the bit line select transistor 216, and the memory cell 202 are connected to a voltage supply. The circuit 200 includes the NLO transistor 222 which may be controlled for certain read operations. The circuit 200 also includes a first inverter S (INV_S) data latch 224A and a second inverter S data latch 224B for controlling the inhabit/non-inhabit bit line.

For ease of understanding, the disclosure illustrates the source ground source transistor 206 as a one-to-one correspondence with the circuit 200. However, in other examples, the source ground source transistor 206 may have more than a one-to-one correspondence such that the source ground source transistor 206 may support multiple circuits beyond merely the circuit 200.

FIG. 2 specifically illustrates the CELSRC path of the circuit 200 during an erase operation of the memory cell 202. During an erase operation, the cell source low voltage driver 208 and the source ground driver 210 both supply a voltage of approximately 2.2 V. During the erase operation, the source high voltage switch 204 and the source ground source transistor 206 are both in an off state. During the erase operation, the BIAS transistor 214 is in an on state and the bit line select transistor 216 is in an off state. In this manner, the BIAS transistor 214 supplies the bias voltage to the memory cell 202, which erases any stored voltage (e.g., data) within the memory cell 202.

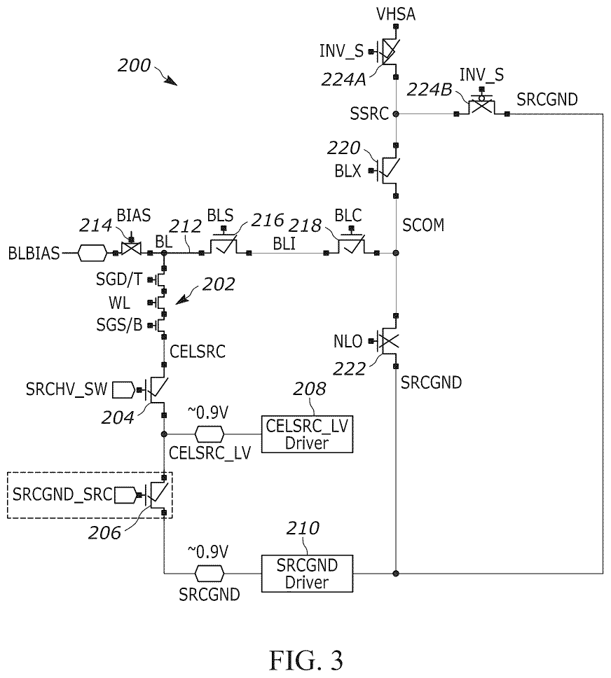

FIG. 3 illustrates the CELSRC path of the circuit 200 during an erase verify operation of the memory cell 202. During an erase verify operation, the cell source low voltage driver 208 and the source ground driver 210 both supply a voltage of between approximately 0.5 V to 1.2 V (for example, approximately 0.9 V). During the erase verify operation, the source high voltage switch 204 and the source ground source transistor 206 are both in an on state. During the erase verify operation, the BIAS transistor 214 is in an off state and the bit line select transistor 216 is in an on state. Additionally, the first inverter S data latch 224A, the BLX transistor 220, and the bit line control transistor 218 may be in an on state while the second inverter S data latch 224B and the non-lock-out transistor 222 are in an off state.

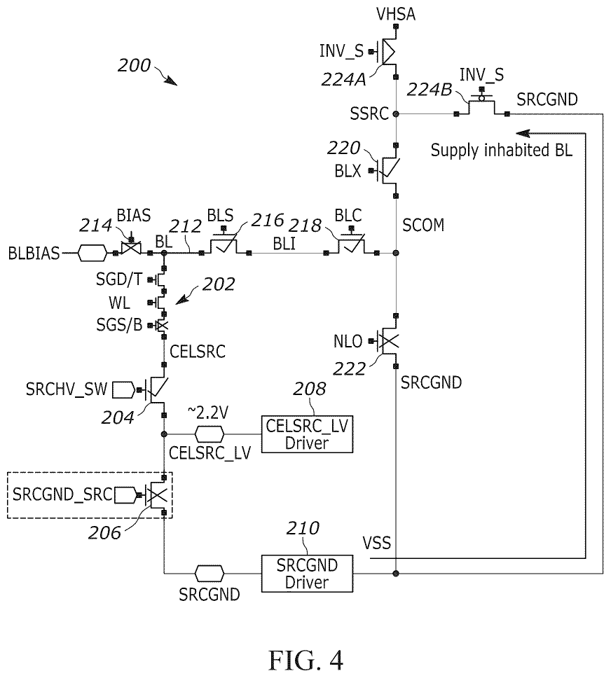

FIG. 4 illustrates the CELSRC path of the circuit 200 during a program (e.g. a write) operation. During a program operation, the cell source low voltage driver 208 supplies a voltage of approximately 2.2 V. The source ground driver 210 supplies a voltage of Vss (for example, a ground voltage of 0 V) to the inhabited bit line, through the second inverter S data latch 224B. During the programming operation, the source ground source transistor 206 is in an off state and the source high voltage switch 204 is in an on state. Additionally, the BLX transistor 220, the bit line control transistor 218, and the bit line select transistor 216 are in an on state, while the BIAS transistor 214 and the non-lock-out transistor 222 in an off state. The first S transistor data latch 224A and the second inverter S data latch 224B are controlled based on whether the corresponding bit line is inhabited (e.g., selected) or is not inhabited. The first S transistor data latch 224A and the second inverter S data latch 224B share a gate voltage such that when one is in the on state, the other is in the off state.

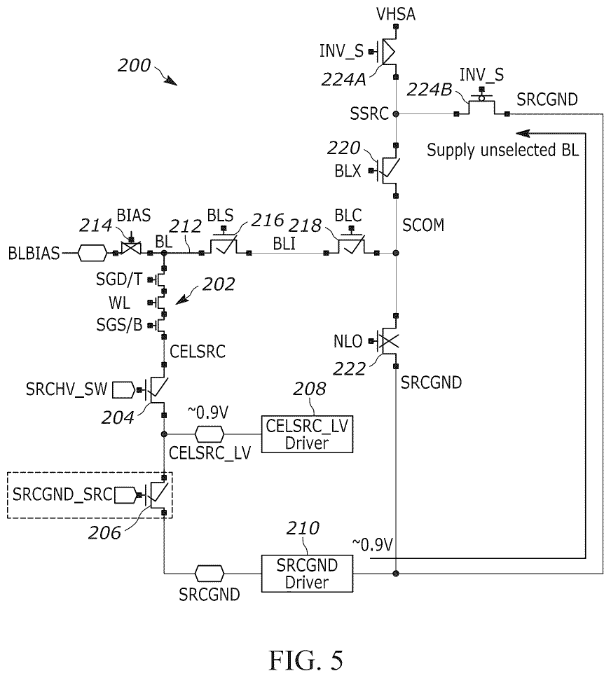

FIG. 5 illustrates the CELSRC path of the circuit 200 during a program verify (e.g., a write verify) operation. During a program verify operation, the cell source low voltage driver 208 supplies a voltage of approximately 0.9 V and the source ground driver 210 supplies a voltage of approximately 0.9 V to the unselected bit line as part of a lockout read procedure. During the program verify operation, the source high voltage switch 204 and the source ground source transistor 206 are both in an on state. Additionally, during the program verify operation, the bit line select transistor 216, the bit line control transistor 218, and the BLX transistor 220 are in an on state while the BIAS transistor 214 and the non-lock-out transistor 222 are in an off state.

As previously noted, physical encryption may be implemented during read operations. When in encryption mode, the cell read voltage of the memory cell 202 may be shifted to alter the read values obtained from the memory cell 202. When in decryption mode, the true cell read voltage may be obtained from the memory cell 202. To control whether the cell read voltage is shifted, examples described herein control the source ground source transistor 206 to be either on or off based on whether the circuit 200 is in the encryption mode or the decryption mode.

In some implementations, the source ground source transistor 206 is controlled based on whether a secret key is input correctly. The secret key may be provided to a control logic. The control logic then outputs a signal to the source ground source transistor 206 indicative of whether the secret key was correct. The signal may be provided to the gate of the source ground source transistor 206. For example, when in the encryption mode, the source ground source transistor 206 may be controlled to an on state. When in the decryption mode, the source ground source transistor 206 may be controlled to an off state. However, the use of the source ground source transistor 206 is just one example of shifting the cell read voltage. The disclosure is applicable to any circuit or process that shifts the cell read voltage while in an encryption mode.

The control logic may be, for example, the data storage device controller 106 comparing the secret key to a secret key stored in the memory 130. In other implementations, the control logic is a series of logical gates (for example, AND gates, OR gates, XOR gates, NOR gates, NAND gates, etc.) configured to provide an output indicative of whether the secret key is a desired or preset secret key. In yet another example, the control logic may be an electronic controller external to and separate from the data storage device 102. For example, the secret key may be received by the host device 108. The host device 108 then transmits a signal to the data storage device controller 106 indicative of whether the secret key was correct. In another instance, the host device 108 receives the secret key and transmits the secret key to the data storage device controller 106. The data storage device controller 106 then determines whether the secret key matches a stored secret key. However, the above examples are just some example variations of using a secret key. The disclosure is applicable to any circuit or process that indicates a secret key is correct.

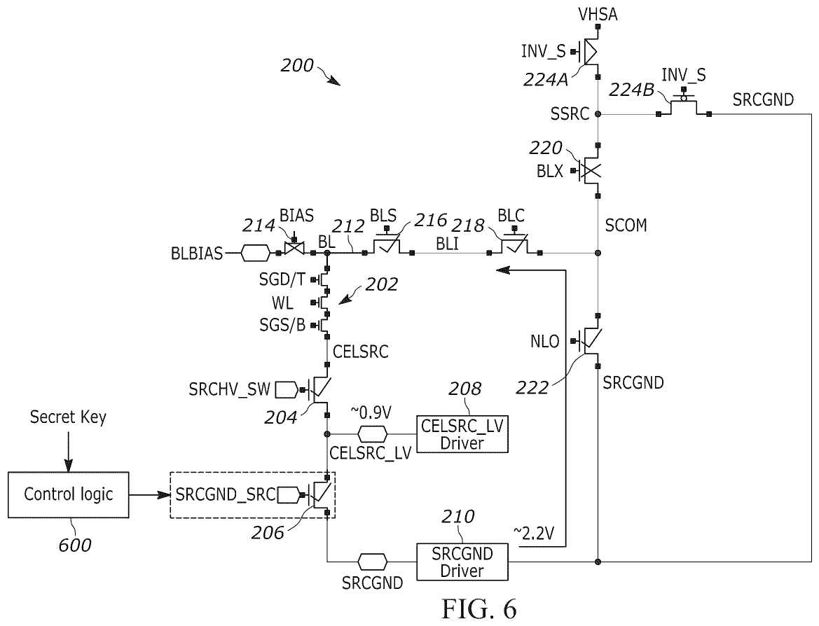

FIG. 6 illustrates the CELSRC path of the circuit 200 during a read operation while in the encryption mode. While in the encryption mode, either the secret key has not yet been received by the control logic 600, or the secret key received by the control logic 600 is incorrect. The control logic 600 controls or maintains the source ground source transistor 206 to be in an on state, thereby enabling or maintaining the encryption mode by shifting the cell read voltage. During read operations, the source high voltage switch 204 is also in an on state. The cell source low voltage driver 208 supplies a voltage of approximately 0.9 V, and the source ground driver 210 supplies a voltage of approximately 2.2 V. Additionally, during read operations, the bit line select transistor 216, the bit line control transistor 218, and the non-lock-out transistor 222 are in on states, while the BIAS transistor 214 and the BLX transistor 220 are in off states.

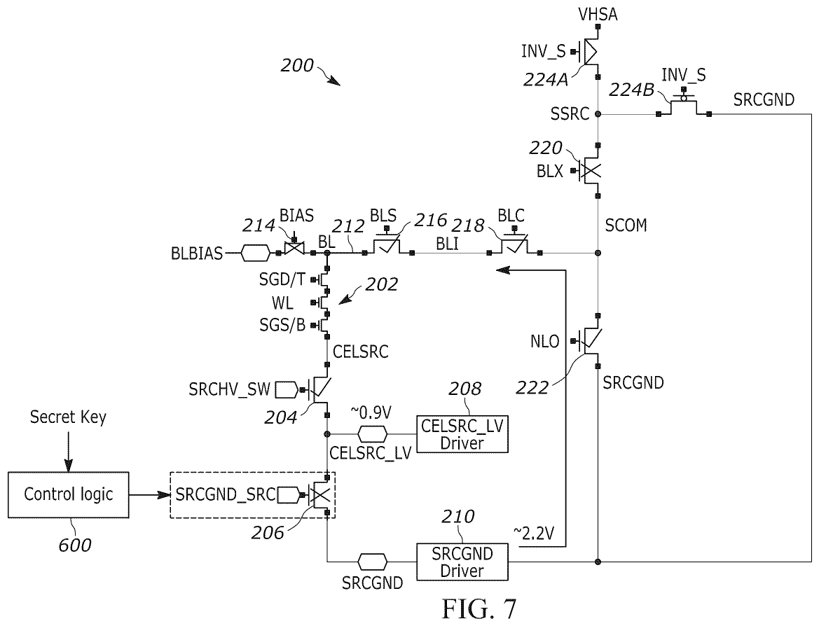

Once the control logic 600 receives the correct secret key, the control logic 600 controls the source ground source transistor 206 to an off state, thereby changing the circuit 200 from the encryption mode to the decryption mode. FIG. 7 illustrates the CELSRC path of the circuit 200 during a read operation while in the decryption mode. The only difference between the encryption mode of FIG. 6 and the decryption mode of FIG. 7 is the state of the source ground source transistor 206.

In some instances, the control logic 600 receives a command in addition to the secret key. The command may be an input indicating that the subsequent input is the secret key (for example, “XX” typed in a keyboard).

In some implementations, such as enterprise self service (ESS) usage, the secret key may be configured such that users are able to generate, abolish, reallocate, and encrypt the secret key dynamically. In other implementations, such as customer self service (CSS) usage, the secret key may be static and stored as part of ROM fuse information.

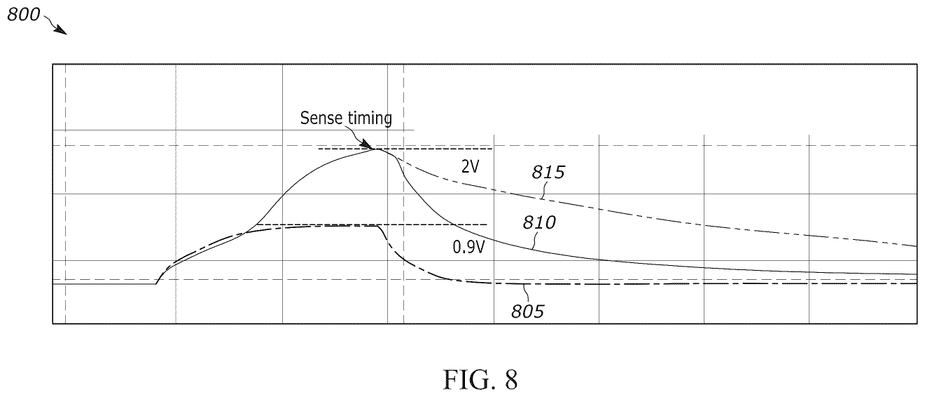

FIG. 8 is a graph 800 illustrating the cell read voltage during read operations based on whether the encryption mode is enabled. A first function 805 represents the cell read voltage during a read operation while the circuit 200 is in the decryption mode. In the decryption mode, the source ground source transistor 206 is in an off state, and the cell read voltage is approximately 0.9 V at the sense timing (e.g., at the read time). The second function 810 and the third function 815 represent the cell read voltage during a read operation while the circuit 200 is in the encryption mode. In the encryption mode, the source ground source transistor 206 is in an on state, and the cell read voltage is approximately 2.0 V at the sense timing. Accordingly, in the encryption state, the cell read voltage experiences a voltage shift of approximately 1.1 V, making the read data different from the stored data.

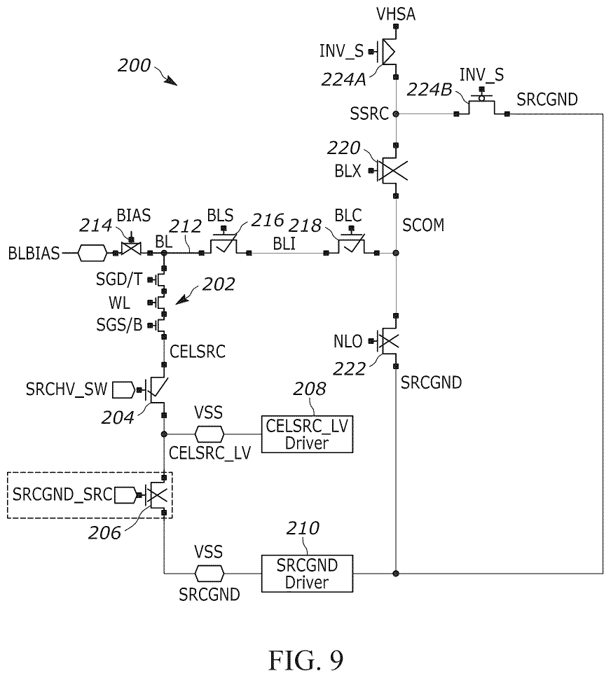

FIG. 9 illustrates the CELSRC path of the circuit 200 during a power-on read operation. During the power-on read operation, the source ground source transistor 206 is in an off state and the source high voltage switch 204 is in an on state. The cell source low voltage driver 208 and the source ground driver 210 both supply Vss voltage. Additionally, the BIAS transistor 214, the BLX transistor 220, and the non-lock-out transistor 222 are in an off state, while the bit line select transistor 216 and the bit line control transistor 218 are in an on state. Voltage sensing may be applied to complete the power-on read operation.

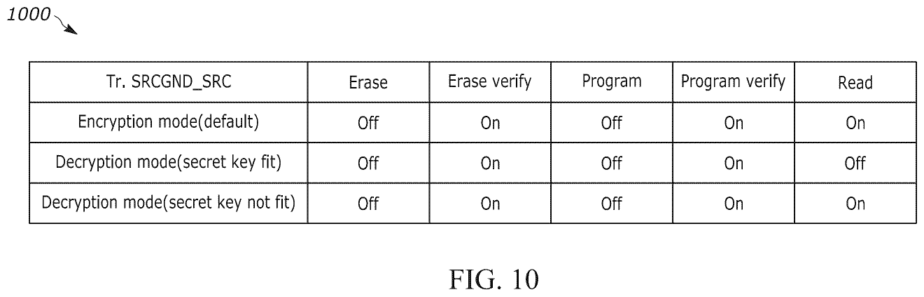

FIG. 10 is a table providing the state of the source ground source transistor 206 for each operation described with respect to FIGS. 2-9. As stated, when in the encryption mode, the source ground source transistor 206 is on during read operations so that the cell read voltage is driven high. Data read is incorrect compared to the stored data as the effective read voltage is shifted and the source-drain voltage may not be sufficient for sensing. However, erase, erase verify, program, program verify, and power-on read operations experience no difference in behavior regardless of whether the encryption mode is enabled.

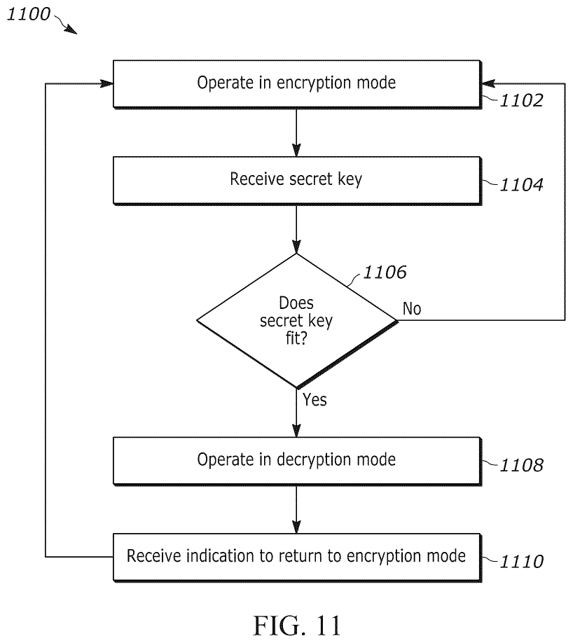

FIG. 11 is a flowchart illustrating an example method 1100 for entering a decryption mode of a data storage device, in accordance with various aspects of the present disclosure. In some implementations, the method 1100 is performed by the electronic processor 128. FIG. 11 is described with respect to FIG. 6.

The method 1100 includes operating, with the electronic processor 128, the data storage device 102 in an encryption mode (at block 1102). For example, the electronic processor 128 controls the source ground source transistor 206 to be in an on state, thereby shifting (e.g., increasing) the effective read voltage of the memory cell 202.

The method 1100 includes receiving, with the electronic processor 128, a secret key (at block 1104). For example, the electronic processor 128 receives a secret key. The method 1100 includes determining whether the secret key is a fit (e.g., is the correct secret key) (at decision block 1106). By way of example, the electronic processor 128 may compare the input secret key to a set secret key stored in the memory 130. When the secret key is not a fit (“NO” at decision block 1106), the secret key does not match an expected key and the method 1100 returns to block 1102 and maintains the source ground source transistor 206 in the on state, thereby maintaining the shift (e.g., increase) in the effective read voltage of the memory cell 202. The electronic processor 128 continues operating the data storage device 102 in the encryption mode (at block 1102).

When the secret key is a fit (“YES” at decision block 1106), the secret key does match an expected key and the method 1100 includes operating, with the electronic processor 128, the data storage device 102 in the decryption mode (at block 1108). For example, the electronic processor 128 controls the source ground source transistor 206 to be in an off state, which removes the shift in the cell read volage and allows the correct cell read voltage of the memory cell 202 to be sensed.

In some implementations, the method 1100 includes receiving, with the electronic processor 128, an indication to return to the encryption mode (at block 1110). For example, the electronic processor 128 enters the encryption mode upon a reset or power down event of the data storage device 102.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A data storage device comprising:
a circuit including a memory cell and a source ground source transistor on a cell source path of the memory cell,
wherein, when the circuit is in a decryption mode, the source ground source transistor is in an off state and the memory cell has an effective read voltage at a first level, and
wherein, when the circuit is in an encryption mode, the source ground source transistor is in an on state and the memory cell has an effective read voltage at a second level different from the first level.

2. The data storage device of claim 1, wherein the circuit is in the encryption mode after a power reset.

3. The data storage device of claim 1, further comprising:
a host interface configured to interface with a host device; and
a controller configured to:
receive, from the host interface, an indication of a secret key; and
control whether the source ground source transistor is in the on state or in the off state based on the indication of the secret key.

4. The data storage device of claim 1, wherein the memory cell is a NAND flash memory cell.

5. The data storage device of claim 1, wherein the source ground source transistor is in the off state during an erase operation of the memory cell.

6. The data storage device of claim 1, wherein the source ground source transistor is in the on state during an erase verify operation of the memory cell.

7. The data storage device of claim 1, wherein the source ground source transistor is in the off state during a program operation of the memory cell.

8. The data storage device of claim 1, wherein the source ground source transistor is in the on state during a program verify operation of the memory cell.

9. A data storage device comprising:
a memory cell;
a source ground source transistor on a cell source path of the memory cell; and
a controller configured to:
control, when in a decryption mode, the source ground source transistor to an on state, wherein, when in the decryption mode, the memory cell has an effective read voltage at a first level, and
control, when in an encryption mode, the source ground source transistor to an off state, wherein, when in the encryption mode, the memory cell has an effective read voltage at a second level different from the first level.

10. The data storage device of claim 9, wherein the controller is further configured to:
receive, when in the encryption mode, a key,
determine whether the key matches an expected key, and
control, when the key matches the expected key, the source ground source transistor to the off state to enable the decryption mode.

11. The data storage device of claim 9, wherein the controller is further configured to:
receive, when in the decryption mode, an indication to return to the encryption mode, and
control, in response to the indication, the source ground source transistor to the on state to enable the encryption mode.

12. The data storage device of claim 9, wherein the controller is further configured to:
control, when performing an erase operation of the memory cell, the source ground source transistor to the off state.

13. The data storage device of claim 9, wherein the controller is further configured to:
control, when performing an erase verify operation of the memory cell, the source ground source transistor to the on state.

14. The data storage device of claim 9, wherein the controller is further configured to:
control, when performing a program operation of the memory cell, the source ground source transistor to the off state.

15. The data storage device of claim 9, wherein the controller is further configured to:
control, when performing a program verify operation of the memory cell, the source ground source transistor to the on state.

16. A method for physical encryption in a data storage device, the method comprising:
controlling, when in a decryption mode, a source ground source transistor to an off state, wherein, when in the decryption mode, a memory cell has an effective read voltage at a first level, and wherein the source ground source transistor is on a cell source path of the memory cell; and
controlling, when in an encryption mode, the source ground source transistor to an on state, wherein, when in the encryption mode, the memory cell has an effective read voltage at a second level different from the first level.

17. The method of claim 16, further comprising:
receiving, when in the encryption mode, a key,
determining whether the key matches an expected key, and
controlling, when the key matches the expected key, the source ground source transistor to the off state to enable the decryption mode.

18. The method of claim 16, further comprising:
receiving, when in the decryption mode, an indication to return to the encryption mode, and
controlling, in response to the indication, the source ground source transistor to the on state to enable the encryption mode.

19. The method of claim 16, further comprising:
controlling, when performing an erase operation of the memory cell, the source ground source transistor to the off state.

20. The method of claim 16, further comprising:
controlling, when performing a program operation of the memory cell, the source ground source transistor to the off state.
